(19) United States
(12) Patent Application Publication
(10) Pub. No.: US 2012/0033184 A1
(43) Pub. Date: Feb. 9, 2012

(54) STEREOSCOPIC VISION GLASSES AND STEREOSCOPIC VISION ELECTRONIC APPARATUS

(75) Inventors: Takaaki Tanaka, Toshima-ku (JP); Akihiko Ito, Tatsuno-machi (JP)

(73) Assignee: Seiko Epson Corporation, Tokyo (JP)

(21) Appl. No.: 13/197,682

(22) Filed: Aug. 3, 2011

(30) Foreign Application Priority Data
Aug. 9, 2010 (JP) 2010-178386

(51) Int. Cl. G02B 27/26; G03B 21/14

(52) U.S. Cl. 353/8; 359/465

(57) ABSTRACT

Stereoscopic vision glasses include a right-eye shutter and a left-eye shutter axisymmetric to each other with respect to a symmetric axis. Each of the right-eye shutter and the left-eye shutter includes an incident side polarization plate, an exit side polarization plate, and liquid crystal interposed therebetween. Each of the right-eye shutter and the left-eye shutter is opened or closed in accordance with an application voltage of the liquid crystal. The polarization axis of the incident side polarization plate of each of the right-eye shutter and the left-eye shutter is inclined with respect to the symmetric axis. A stereoscopic vision electronic apparatus includes a projection type display device displaying a right-eye image and a left-eye image in a time division manner by projecting first projected light and second projected light of which directions of polarization axes are different from each other; and the stereoscopic vision glasses.

### BACKGROUND

1. Technical Field

The present invention relates to a technique for stereoscopically viewing an image.

2. Related Art

Hitherto, there has been suggested a frame sequential type stereoscopic vision method of viewing a stereoscopic vision image by displaying a right-eye image and a left-eye image having right and left parallaxes in a time division manner. In the frame sequential method, different images having right and left parallaxes are provided to the right and left eyes of a user so as to recognize a stereoscopic vision image when the user wears glasses (active shutter glasses) having a right-eye shutter and a left-eye shutter which are alternately opened and closed in synchronization with the image displayed in the time division manner (see JP-A-2009-152897).

The frame sequential method can be used for a direct-view display device and a projection type display device (such as a liquid crystal projector of a three-plate light valve type) in which liquid crystal light valves for red light, green light, and blue light are used.

In general, in the liquid crystal projector having the three-plate light valve, an alignment direction of liquid crystal is made different for each liquid crystal light valve in order to prevent display unevenness from occurring due to a difference in visual angle characteristics of the respective liquid crystal light valves. Accordingly, projected light projected from the liquid crystal projector is polarized, so that the projection light has a different polarization axis for each color (that is, wavelength band).

In the example shown in FIG. 1, a projected light Lp projected from a projection type display device 100 includes red polarized light and blue polarized light vibrating in a vertical direction and green polarized light vibrating in a horizontal direction. The projected light Lp is diffusely reflected from a scattering type screen 200 such as a mat screen, but a polarized light component remains in reflected light Lr for each color to some extent. The reflected light Lr passes through an opened right-eye shutter 310 or an opened left-eye shutter 320, so that transmitted light Lt is formed.

Here, as shown in FIG. 2A, when a polarization plate on the incident side of the liquid crystal shutter has a vertical transmission axis, the red polarized light and the blue polarized light vibrating in the vertical direction pass through the incident side polarization plate but the green polarized light vibrating in the horizontal direction does not pass through the incident side polarization plate. For this reason, the transmitted light Lt may be tinged with red and blue (that is, purple) compared to the projected light Lp. As shown in FIG. 2B, when the incident side polarization plate has a horizontal transmission axis, the green polarized light passes through the incident side polarization plate, but the red polarized light and the blue polarized light do not pass through the incident side polarization plate. For this reason, the transmitted light Lt may be tinged with green compared to the projected light Lp. That is, in this case, a problem may arise in that a target color is not sufficiently displayed.

In order to resolve this problem, there has been suggested a method of switching a polarization axis of projected light of each color by using a polarized light modulator that selectively rotates a polarization axis of light with a specific wavelength (JP-A-2008-20921).

However, when the method of rotating the polarization axis using the polarized light modulator according to the related art is used, the configuration of the projection type display device may become complicated. Therefore, a problem arises in that manufacturing is difficult and manufacturing cost increase.

### SUMMARY

An advantage of some aspects of the invention is that it provides a technique for reducing an influence of a difference between polarization axes on a target color even when the polarization axes of a plurality of projected light have different configurations.

According to an aspect of the invention, there is provided stereoscopic vision glasses including a right-eye shutter and a left-eye shutter disposed axisymmetric to each other with respect to a symmetric axis. Each of the right-eye shutter and the left-eye shutter includes an incident side polarization plate, an exit side polarization plate, and liquid crystal interposed between the incident side polarization plate and the exit side polarization plate. Each of the right-eye shutter and the left-eye shutter is opened or closed in accordance with an application voltage of the liquid crystal. The polarization axis of the incident side polarization plate of each of the right-eye shutter and the left-eye shutter is inclined with respect to the symmetric axis.

The term “symmetric axis” according to the aspect of the invention is a central line of the stereoscopic vision glasses and is a straight line perpendicular to the arrangement direction of the right-eye shutter and the left-eye shutter. Further, the clause “the polarization axis is inclined with respect to the symmetric axis” means that the polarization axis is not parallel to the symmetric axis and the polarization axis is not perpendicular to the symmetric axis.

In the stereoscopic vision glasses according to the aspect of the invention, the polarization axis of the incident side polarization plate of each of the right-eye shutter and the left-eye shutter is inclined with respect to the symmetric axis. Therefore, even when light having polarized light vibrating in a vertical direction (which is a direction parallel to the symmetric axis) and polarized light vibrating in a horizontal direction (which is a direction perpendicular to the symmetric axis) is incident on the stereoscopic vision glasses, a difference between the intensity of the component vibrating in the horizontal direction in the reflected light of the projected light and the intensity of the component vibrating in the vertical direction in the reflected light is reduced further, compared to a case where the polarization axis of the incident side polarization plate of each of the right-eye shutter and the left-eye shutter is parallel or perpendicular to the symmetric axis. Accordingly, it is possible to reduce an influence of the difference in the polarization axis of the projected light on a target hue.

In the stereoscopic vision glasses, the polarization axis of the incident side polarization plate of each of the right-eye shutter and the left-eye shutter may be inclined at an angle range of 45°±5° with respect to the symmetric axis.

In this case, since the difference between the intensity of the component vibrating in the horizontal direction in the reflected light of the projected light and the intensity of the component vibrating in the vertical direction in the reflected light is reduced, it is possible to reduce the influence of the difference in the polarization axis of the projected light on a target hue.

In the stereoscopic vision glasses, the polarization axis of the incident side polarization plate of the right-eye shutter and the polarization axis of the incident side polarization plate of the left-eye shutter may be axisymmetric to each other with respect to the symmetric axis.

In this case, it is possible to equalize the difference in the visual angle characteristics of each incident side polarization plate.

According to another aspect of the invention, there is provided a stereoscopic vision electronic apparatus including: a projection type display device displaying a right-eye image and a left-eye image in a time division manner by projecting first projected light and second projected light of which directions of polarization axes are different from each other; and the above-described stereoscopic vision glasses.

The first projected light and the second projected light may have hues different from each other. Each of the first projected light and the second projected light may have polarization axes of two or more directions different from each other.

### BRIEF DESCRIPTION OF THE DRAWINGS

The invention will be described with reference to the accompanying drawings, wherein like numbers reference like elements.

FIG. 1 is a schematic diagram illustrating a stereoscopic vision electronic apparatus.

FIGS. 2A and 2B are diagrams illustrating a relationship among reflected light, a transmission axis direction of an incident side polarization plate, and transmitted light in a technique according to the related art.

FIG. 3 is a diagram illustrating an example of the configuration of the projection type display device according to an embodiment of the invention.

FIG. 4 is a diagram illustrating an example of the configuration of stereoscopic vision glasses according to the embodiment.

FIG. 5 is a sectional view illustrating a liquid crystal shutter of the stereoscopic vision glasses according to the embodiment of the invention.

FIG. 6 is a diagram illustrating a relationship between horizontal and vertical direction components of incident light and a polarization axis of a polarization plate.

FIG. 7 is a diagram illustrating a variation in the intensity of the horizontal and vertical direction components of the incident light with respect to an angle of the polarization axis of the polarization plate.

FIG. 8 is a diagram illustrating an experiment result of a variation in the color of light passing through the right-eye shutter or the left-eye shutter when an angle of the polarization axis of an incident side polarization plate is varied according to the embodiment of the invention.

FIGS. 9A to 9C are diagrams illustrating examples of the configuration of stereoscopic vision glasses according to modifications of the invention.

### DESCRIPTION OF EXEMPLARY EMBODIMENTS

### 1. Embodiment

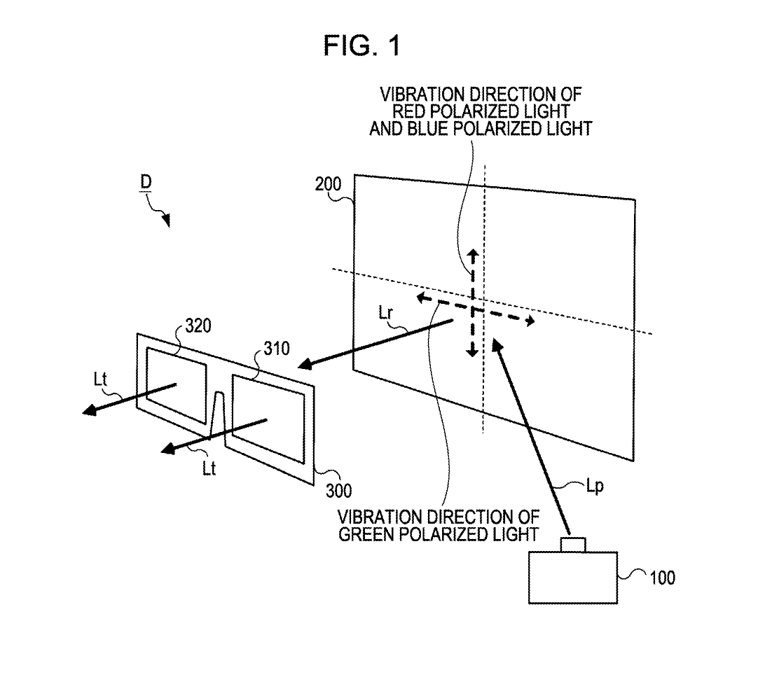

FIG. 1 is a schematic diagram illustrating a stereoscopic vision electronic apparatus D according to an embodiment of the invention. The stereoscopic vision electronic apparatus D is a display apparatus that stereoscopically displays color images mutually having a parallax and includes a projection type display device 100 and stereoscopic vision glasses 300. The projection type display device 100 projects projected light Lp onto a scattering screen 200 to display an image. An observer wears the stereoscopic vision glasses 300. The reflected light Lr formed when the projected light Lp is reflected from the surface of the scattering screen 200 and passing through the stereoscopic vision glasses 300 is perceived by the observer.

FIG. 3 is a schematic diagram illustrating the projection type display device. The projection type display device 100 according to the embodiment is a liquid crystal projector that uses transmission type liquid crystal panels as light valves 110 (110R, 110G, and 110B). A lamp unit 102 serving as a white light source such as a halogen lamp is installed inside the projection type display device 100. Light emitted from the lamp unit 102 is separated into red light, green light, and blue light by three mirrors 106 and two dichroic mirrors 108 installed in the projection type display device 100 and the separated red light, green light, and blue light are guided to light valves 110R, 110G, and 110B, respectively. The light of these colors is modulated and polarized by the respective light valves. Among polarized light of the respective colors, red polarized light and blue polarized light have a vertical polarization axis and green polarized light has a horizontal polarization axis. The polarized light of the respective colors is incident on a dichroic prism 112 from the three directions. The red polarized light and the blue polarized light are refracted by 90° by the dichroic prism 112, whereas the green polarized light travels straightly. Thus, the projected Lp formed by mixing the red polarized light, the green polarized light, and the blue polarized light with each other is projected onto the scattering screen 200 via a projection lens 114.

The projection type display device 100 further includes a control unit 150 that controls the stereoscopic vision glasses 300 in synchronization with display of an image.

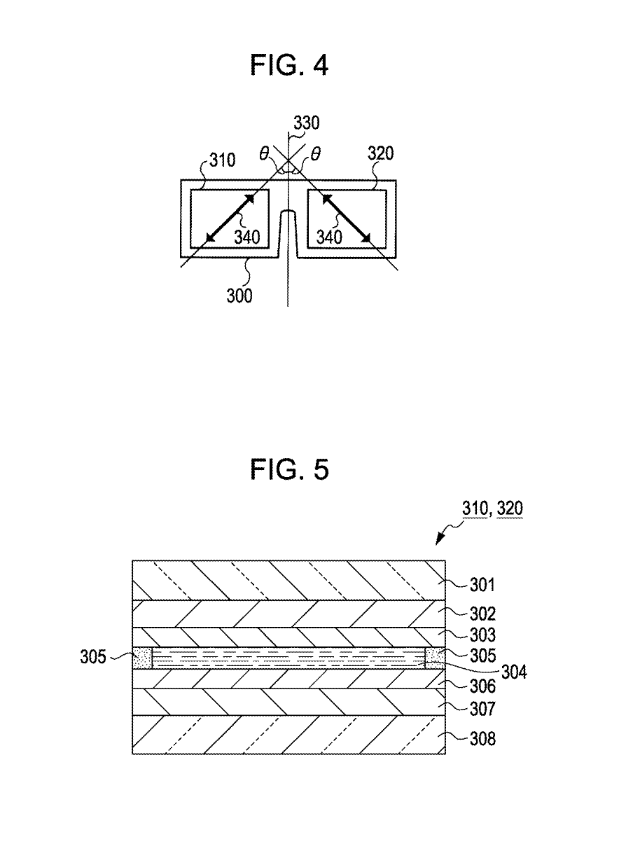

FIG. 4 is a diagram illustrating the configuration of the stereoscopic vision glasses 300 when viewed from the front side (the incident side of the reflected light Lr coming from the scattering screen 200). As shown in FIG. 4, the stereoscopic vision glasses 300 is active shutter glasses that include a right-eye shutter 310 and a left-eye shutter 320 axisymmetric to each other with respect to a symmetric axis 330. The symmetric axis 330 is a central line of the stereoscopic vision glasses 300 and a straight line perpendicular to an arrangement direction of the right-eye shutter 310 and the left-eye shutter 320. Accordingly, when the observer wearing the stereoscopic vision glasses 300 views the scattering screen 200 at an erect posture of the upper part of his or her body, the symmetric axis 330 of the stereoscopic vision glasses 300 is oriented in a direction parallel to the vertical direction.

Since the right-eye shutter 310 and the left-eye shutter 320 are configured by a liquid crystal shutter, the right-eye shutter 310 and the left-eye shutter 320 perform a shutter operation of transmitting and blocking incident light.

FIG. 5 is a sectional view illustrating the right-eye shutter 310 and the left-eye shutter 320 of the stereoscopic vision glasses 300 according to the embodiment. The right-eye shutter 310 and the left-eye shutter 320 each have a configuration in which liquid crystal 304 is sealed between substrates 302 and 307 facing each other. The substrate 302 is located on the incident side of the reflected light Lr and the substrate 307 is located on the exit side (observer side) of the reflected light Lr. Electrodes 303 are formed on the entire region of the substrate 302 facing the liquid crystal 304 and electrodes 306 are formed on the entire region of the substrate 307 facing the liquid crystal 304. The substrate 302 on which the electrodes 303 are formed and the substrate 307 on which the electrodes 306 are formed are adhered to each other by an adhesive 305. An incident side polarization plate 301 is attached to the surface of the substrate 302 opposite to the liquid crystal 304 and an exit side polarization plate 308 is attached to the surface of the substrate 307 opposite to the liquid crystal 304.

Each of the right-eye shutter 310 and the left-eye shutter 320 having the above-described configuration is opened or closed in accordance with a voltage (application voltage to the liquid crystal) between the electrodes 303 and the electrodes 306. The term “opened” means that the reflected light Lr incident from the incident side polarization plate 310 passes through the liquid crystal and exits from the exit side polarization plate 308 toward the observer. The term “closed” means that the reflected light Lr incident from the incident side polarization plate 301 is blocked and thus does not exit toward the observer.

The alignment mode of the liquid crystal 304 of each of the right-eye shutter 310 and the left-eye shutter 320 is not particularly limited. Various alignment modes such as VA (Vertical Alignment), TN (Twisted Nematic), STN (Super Twisted Nematic), FLC (Ferroelectric Liquid Crystal), OCB (Optically Compensated Bend), and ECB (Electrically Controlled Birefringence) can be used.

The projection type display device 100 alternately projects right-eye and left-eye images as the projected light Lp to the scattering screen 200 in a time division manner. The projected light Lp is reflected from the scattering screen 200 and is turned into the reflected light Lr. Then, the reflected light Lr is incident on the stereoscopic vision glasses 300. The control unit 150 of the projection type display device 100 opens the right-eye shutter 310 and closes the left-eye shutter 320, when the right-eye image is projected. On the contrary, the control unit 150 closes the right-eye shutter 310 and opens the left-eye shutter 320, when the left-eye image is projected. As a consequence, the reflected light Lr passes through the opened right-eye shutter 310 or the opened left-eye shutter 320 and is turned into the transmitted light Lt. Then, the right-eye image is provided to only the right eye of the observer and the left-eye image is provided to only the left eye of the observer, so that the observer can perceive a stereoscopic vision image.

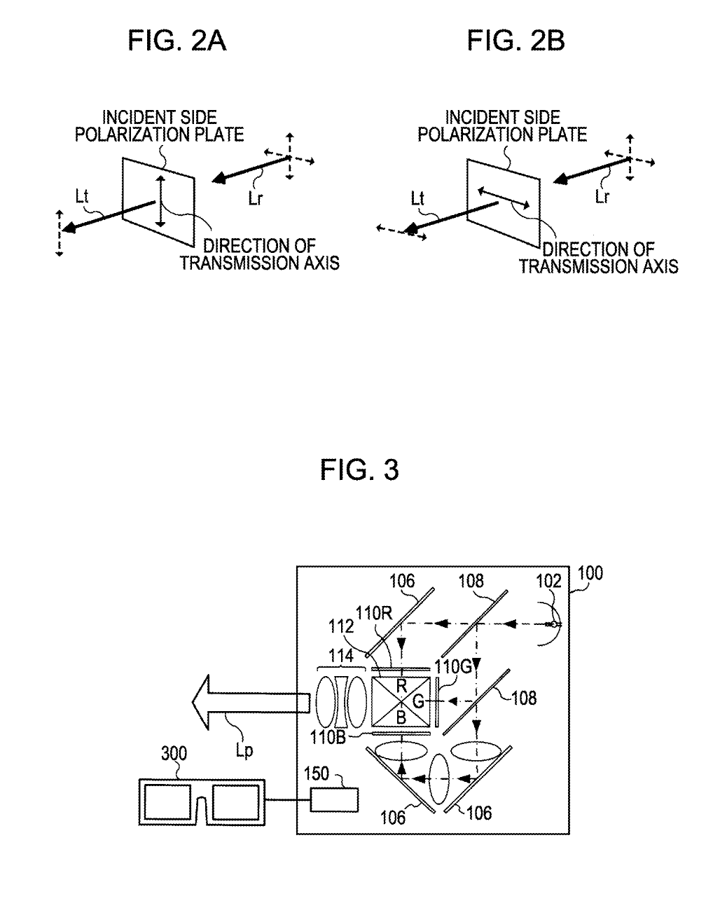

As described above, the projected light Lp and the reflected light Lr for displaying the stereoscopic vision image include red and blue components vibrating a vertical direction and a green component vibrating a horizontal direction. Accordingly, when the direction of the polarization axis 340 of the incident side polarization plate 301 of each of the right-eye shutter 310 and the left-eye shutter 320 is set to a vertical direction or a horizontal direction, as described with reference to FIGS. 2A and 2B, a target color is inhibited from being sufficiently perceived by the observer. In order to reduce color irregularity caused due to a difference in the vibration direction of each color light component, in this embodiment, the polarization axis 340 of the incident side polarization plate 301 of each of the right-eye shutter 310 and the left-eye shutter 320 is set to be inclined with respect to the symmetric axis 330.

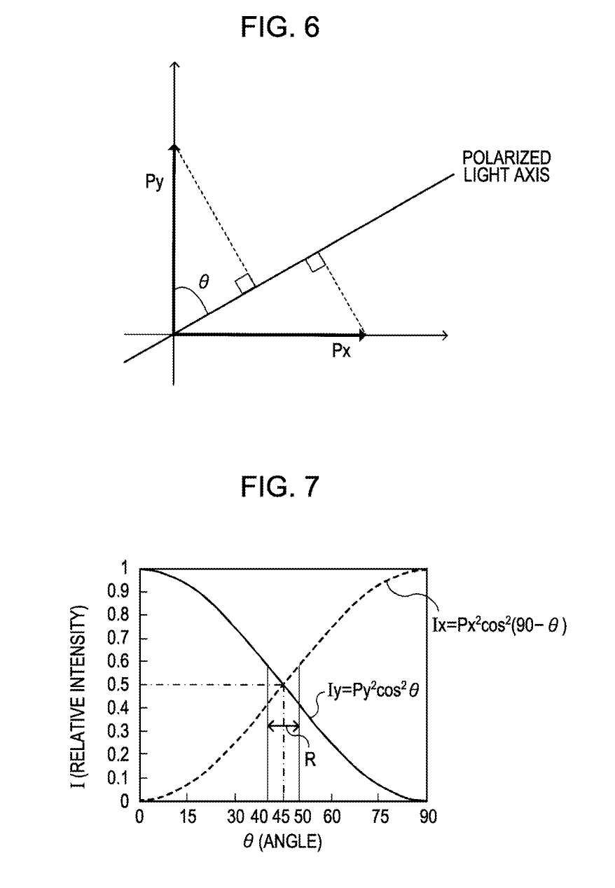

Here, the intensity of the transmitted light will be examined when horizontal polarized light and vertical polarized light are incident on the incident side polarization plate 301 in which the polarization axis (transmission axis) 340 forms an angle θ with respect to the symmetric axis 330. As shown in FIG. 6, when incident light passes through the polarization plate having a polarization axis inclined only at an angle θ[°] from the a vertical direction on the assumption that Px denotes the amplitude of a component vibrating a horizontal direction and Py denotes the amplitude of a component vibrating in a vertical direction, an intensity Ix of the horizontal component of the transmitted light and an intensity Iy of the vertical component of the transmitted light can be expressed as follows:

Ix=Px² cos²(90°−θ);

and

Iy=Py² cos²θ.

The entire intensity of the transmitted light can be expressed as the sum of the respective components, that is, Ix+Iy.

FIG. 7 is a graph illustrating a relationship between the angle θ of the polarization axis 340 of the incident side polarization plate 301 with respect to the vertical direction and the intensity Ix of the horizontal component of the transmitted light and the intensity Iy of the vertical component of the transmitted light. The intensities Ix and Iy are a relative intensity normalized so that the minimum value becomes 0 and the maximum value becomes 1.

When the angle θ is 0° (when the polarization axis 340 of the incident side polarization plate 301 is parallel to the vertical direction), only the vertical component of the incident light passes through the incident side polarization plate 301. Therefore, as shown in FIG. 7, the intensity Iy of the vertical component of the transmitted light has the maximum value (1) and the intensity Ix of the horizontal component has the minimum (0). As the angle θ is increased from 0°, a ratio of the vertical polarized component of the incident light blocked by the incident side polarization plate 301 increases and a ratio of the horizontal polarized component of the incident light passing through the incident side polarization plate 301 increases.

When the angle θ becomes 45°, the magnitudes of the intensities Ix and Iy are reversed. When the angle θ is 90° (when the polarization aix 340 of the incident side polarization plate 301 is parallel to the horizontal direction), the intensity Ix of the horizontal component of the transmitted light becomes the maximum value (1) and the intensity Iy of the vertical component of the transmitted light becomes the minimum value (0).

That is, the angle θ of the polarization axis 340 of the incident side polarization plate 301 is 0° or 90°, a difference (that is, an influence of a difference in the polarized direction of the incident light on the transmitted light) between the intensities Ix and Iy of the transmitted light becomes the maximum. On the other hand, when the angle θ is inclined with respect to the symmetric axis in the horizontal direction or the vertical direction (θ≠0° and) θ≠90°, the difference between the intensities Ix and Iy is suppressed. In particular, when the angle θ is 45°, the difference between the intensities Ix and Iy becomes the minimum (Ix=Iy=0.5).

The polarization axis 340 of the incident side polarization plate 301 of each of the right-eye shutter 310 and the left-eye shutter 320 is set so as to be inclined with respect to the symmetric axis 330 (vertical direction) in consideration of the above-mentioned tendency, as shown in FIG. 4. That is, the angle θ of the polarization axis 340 with respect to the symmetric axis 330 is set as an angle other than 0° and 90°. Specifically, as described with reference to FIG. 7, the angle θ is set to fall within a range R of 45°±5° so that the difference between the intensities Ix and Iy is effectively suppressed. Most preferably, the angle θ is set to 45° so that the difference between the intensities Ix and Iy becomes the minimum (0). The polarization axis 340 of the incident polarization plate 301 of the right-eye shutter 310 and the polarization axis 340 of the incident polarization plate 301 of the left-eye shutter 320 are axisymmetric to each other with respect to the symmetric axis 330. On the other hand, the direction of the polarization axis of the exit side polarization plate 308 of each of the right-eye shutter 310 and the left-eye shutter 320 is determined in accordance with the direction of the polarization axis 340 of the incident polarization plate 301 and the alignment mode of the liquid crystal.

As described above, since the polarization axis 340 of the incident side polarization plate 301 of each of the right-eye shutter 310 and the left-eye shutter 320 is inclined with respect to the symmetric axis 330 (vertical direction), it is possible to reduce the color irregularity caused due to the difference in the vibration direction of each color light component. That is, even when the reflected light Lr having the component (green polarized light) vibrating in the horizontal direction (which is a direction perpendicular to the symmetric axis 330) and the components (the red polarized light and the blue polarized light) vibrating in the vertical direction (which is a direction parallel to the symmetric axis 330) is incident on the stereoscopic vision glasses 300, it is possible to reduce the color irregularity caused due to the difference in the polarization axis.

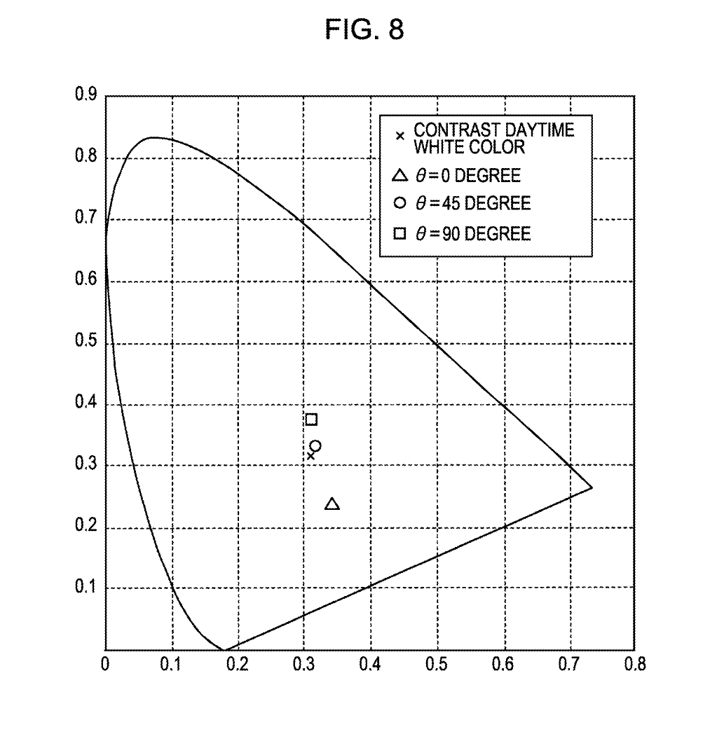

FIG. 8 is a diagram illustrating an experiment result of a variation in the color of the light passing through the right-eye shutter 310 or the left-eye shutter 320 when the angle θ of the polarization axis 340 of the incident side polarization plate 301 is varied. The hue of the transmitted light Lt obtained when the white reflected light Lr is incident on the right-eye shutter 310 or the left-eye shutter 320 and the hue of contrast daytime white color (D65 standard light) are plotted on the xy chromaticity diagram of CIE (Commission International del'Eclairage), when the angles between the polarization axis 340 and the symmetric axis 330 are θ=0°, θ=45°, and θ=90°.

The hue of the daytime white is (x, y)=(0.3127, 0.3290). When θ=0°, the hue is (x, y)=(0.343, 0.240) and a distance with the daytime white on the chromaticity diagram is 0.0940. When θ=90°, the hue is (x, y)=(0.313, 0.375) and a distance with the daytime white on the chromaticity diagram is 0.0460. When θ=45°, the hue is (x, y)=(0.317, 0.332) and a distance with the daytime white on the chromaticity diagram is 0.0052 and is the smallest compared to the case where θ=0° and the case where θ=90°.

That is, compared to the cases where the angle θ formed between the polarization axis 340 and the symmetric axis 330 is 0° and 90°, the hue of the transmitted light Lt in the case where θ=45° is near the white which is the hue of the incident reflected light Lr and it can be said that the influence of the difference in the vibration direction of the polarized component on the hue perceived by the observer is reduced.

### 2. Modifications

Two or more selected modifications among the modifications described below may be combined appropriately as long as the combination is not contradictory.

In the above-described embodiment, the angle of 45°±5° between the polarization axis 340 of the incident side polarization plate 301 of the right-eye shutter 310 and the polarization axis 340 of the incident side polarization plate 301 of the left-eye shutter 320 is formed with respect to the symmetric axis 330, but the angle between the polarization axes 340 is not limited thereto. That is, the polarization axes 340 may be inclined with respect to the symmetric axis 330. Even in this case, the difference between the intensity of the component vibrating in the horizontal direction in the reflected light Lr and the intensity of the component vibrating the vertical direction in the reflected light Lr is smaller compared to a case the polarization axis 340 of the incident side polarization plate 301 of each of the right-eye shutter 310 and the left-eye shutter 320 is parallel or perpendicular to the symmetric axis 330. Therefore, it is possible to reduce the influence of the difference in the polarization axis on the hue.

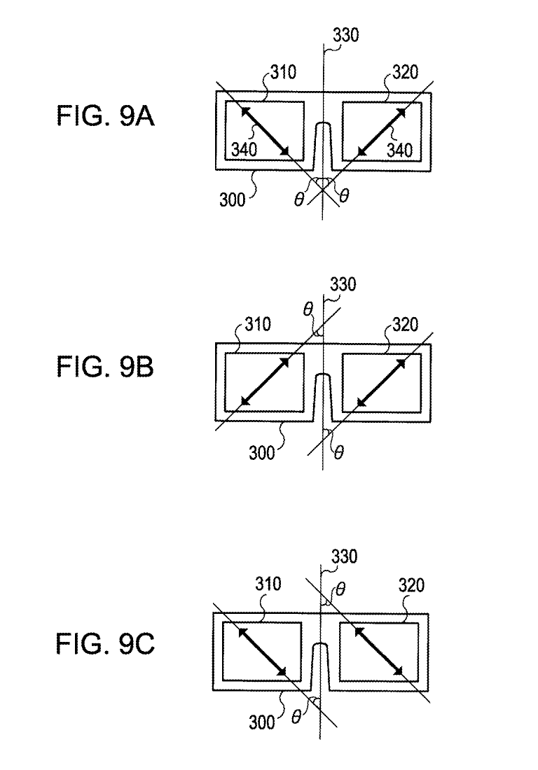

In the above-described embodiment, the polarization axis 340 of the incident side polarization plate 301 of the right-eye shutter 310 and the polarization axis 340 of the incident side polarization plate 301 of the left-eye shutter 320 in the stereoscopic vision glasses 300 intersect each other in the upper portion of the stereoscopic vision glasses 300, but the invention is not limited thereto. As shown in FIG. 9A, the polarization axis 340 of the incident side polarization plate 301 of the right-eye shutter 310 and the polarization axis 340 of the incident side polarization plate 301 of the left-eye shutter 320 may intersect each other in the lower portion of the stereoscopic vision glasses 300.

In the above-described embodiment, the polarization axis 340 of the incident side polarization plate 301 of the right-eye shutter 310 and the polarization axis 340 of the incident side polarization plate 301 of the left-eye shutter 320 are axisymmetric to each other with respect to the symmetric axis 330. However, the polarization axes 340 may not be axisymmetric to each other with respect to the symmetric axis 330. For example, as shown in FIGS. 9B and 9C, the polarization axis 340 of the incident side polarization plate 301 of the right-eye shutter 310 and the polarization axis 340 of the incident side polarization plate 301 of the left-eye shutter 320 may be oriented in the same direction. In this case, since the configuration of the right-eye shutter 310 can be made to be the same as that of the left-eye shutter 320, the configuration of the stereoscopic vision glasses 300 can be simplified. However, when the polarization axes 340 of the incident side polarization plates 301 are axisymmetric to each other with respect to the symmetric axis 330, as in FIG. 4 or 9A, it is possible to obtain the advantage of equalizing the visual angle characteristics of the incident side polarization plate 301 of the right-eye shutter 310 and the incident side polarization plate 301 of the left-eye shutter 320.

In the above-described embodiment, the angle θ formed between the polarization axis 340 of the incident side polarization plate 301 of the right-eye shutter 310 and the symmetric axis 330 is the same as the angle θ formed between the polarization axis 340 of the incident side polarization plate 301 of the left-eye shutter 320 and the symmetric axis 330, but these angles may be different from each other.

In the above-described embodiment, the red polarized light and the blue polarized light of the projected light Lp from the projection type display device 100 vibrate in the vertical direction and the green polarized light vibrates in the horizontal direction, but the vibration direction of each color light component is arbitrary. The projected light Lp from the projection type display device 100 may include first projected light and second projected light of which the directions of the polarization axis is different. Even in this case, by using the above-described stereoscopic vision glasses 300, it is possible to reduce the influence of the difference in the polarization axis of the projected light on the hue.

The hues of the first projected light and the second projected light may be same as each other or may be different from each other. The direction of the polarization axis of the first projected light and the second projected light is not limited to one. The polarization axis may have two or more directions different from each other. Even in this case, by using the above-described stereoscopic vision glasses 300, it is possible to reduce the influence of the difference in the polarization axis of the projected light on the hue.

In the above-described embodiment, the scattering screen 200 is used as a screen to which the projected light Lp from the projection type display device 100 is reflected. However, the invention is not limited thereto. Another screen such as a recurrence screen or a reflection screen may be used.

The entire disclosure of Japanese Patent Application No. 2010-178386, filed Aug. 9, 2010 is expressly incorporated by reference herein.

What is claimed is:

1. Stereoscopic vision glasses comprising:
a right-eye shutter and a left-eye shutter disposed axisymmetric to each other with respect to a symmetric axis,
wherein each of the right-eye shutter and the left-eye shutter includes an incident side polarization plate, an exit side polarization plate, and liquid crystal interposed between the incident side polarization plate and the exit side polarization plate,
wherein each of the right-eye shutter and the left-eye shutter is opened or closed in accordance with an application voltage of the liquid crystal, and
wherein the polarization axis of the incident side polarization plate of each of the right-eye shutter and the left-eye shutter is inclined with respect to the symmetric axis.

2. The stereoscopic vision glasses according to claim 1, wherein the polarization axis of the incident side polarization plate of each of the right-eye shutter and the left-eye shutter is inclined at an angle range of 45°±5° with respect to the symmetric axis.

3. The stereoscopic vision glasses according to claim 1, wherein the polarization axis of the incident side polarization plate of the right-eye shutter and the polarization axis of the incident side polarization plate of the left-eye shutter are axisymmetric to each other with respect to the symmetric axis.

4. A stereoscopic vision electronic apparatus comprising:
a projection type display device displaying a right-eye image and a left-eye image in a time division manner by projecting first projected light and second projected light of which directions of polarization axes are different from each other; and
the stereoscopic vision glasses according to claim 1.

5. A stereoscopic vision electronic apparatus comprising:
a projection type display device displaying a right-eye image and a left-eye image in a time division manner by projecting first projected light and second projected light of which directions of polarization axes are different from each other; and
the stereoscopic vision glasses according to claim 2.

6. A stereoscopic vision electronic apparatus comprising:
a projection type display device displaying a right-eye image and a left-eye image in a time division manner by projecting first projected light and second projected light of which directions of polarization axes are different from each other; and
the stereoscopic vision glasses according to claim 3.

7. The stereoscopic vision electronic apparatus according to claim 4,
wherein the first projected light and the second projected light have hues different from each other, and
wherein each of the first projected light and the second projected light has polarization axes of two or more directions different from each other.

8. The stereoscopic vision electronic apparatus according to claim 5,
wherein the first projected light and the second projected light have hues different from each other, and
wherein each of the first projected light and the second projected light has polarization axes of two or more directions different from each other.

9. The stereoscopic vision electronic apparatus according to claim 6,
wherein the first projected light and the second projected light have hues different from each other, and
wherein each of the first projected light and the second projected light has polarization axes of two or more directions different from each other.
